(19) United States
(12) Patent Application Publication
(10) Pub. No.: US 2011/0189335 A1
(43) Pub. Date: Aug. 4, 2011

(54) ANIMAL ATTRACTANT

(76) Inventor: Frederick Wade Mussawir-Key, Kent (GB)

(21) Appl. No.: 13/059,111

(22) PCT Filed: Aug. 15, 2008
(86) PCT No.: PCT/GB09/01943

§ 371 Date: Apr. 21, 2011

(51) Int. Cl. A23K 1/16

(52) U.S. Cl. 426/1

(57) ABSTRACT

There is provided animal attractants and in particular attractants for enhancing the attractiveness of food substances for consumption by a target animal, such as pet cats and dogs. The attractant is in the form of a sprayable liquid having organoleptic properties and that can be selectively dispensed onto the surface of or within a substance such as a food substance, to stimulate one or both of the smell and/or taste senses of a target animal to encourage the animal to consume the substance. The attractant comprises an oil or substantially wholly oil carrier in which is an olfactory and/or flavoring. The attractant may also be used to encourage the consumption of substances such as medicines, food supplements and dietetic preparations.

The present invention relates to animal attractants and, in particular, attractants for enhancing the attractiveness of a substance for consumption by a target animal, and a method of enhancing the attractiveness of such substances.

There are many instances when the inherent attractiveness of a substance is insufficient to attract an animal to consume it, despite the necessity or desirability of the animal to consume the substance. For example, pet dogs and cats can often find food insufficiently attractive to willingly or repeatedly consume the product either in sufficient amounts, sufficiently quickly or at all. Often it is found that ill animals or animals recuperating from surgery or illness, or elderly animals have reduced appetites and the inherent attractiveness of substances such as regular pet food for their consumption can be diminished in such situations. Also, certain dietary requirements, such as low protein and/or low fat diets can render food relatively bland and unattractive to consume.

Further, it can be a problem to orally administer medication to animals. Often, an animal is encouraged to swallow medication by providing the medication on or in foodstuffs. However, the strong sense of smell and/or taste of certain animals such as cats and dogs often means that the animal can sense the medication and, therefore, reject the food. Moreover, the texture of solid medicaments such as tablets and powders can deter the animal from ingesting.

According to the present invention, there is provided an attractant for enhancing the attractiveness of a substance for consumption by a target animal, the attractant comprising a carrier being wholly or substantially wholly oil and one or both of an olfactory agent and flavouring dispersed in the carrier, such that the attractant when dispensed on and/or in the substance stimulates one or both of the smell and/or taste senses of a target animal to encourage consumption.

Preferably the attractant is sprayable.

Preferably, the attractant enhances the inherent attractiveness of a foodstuff for consumption by a target animal.

The olfactory agent and the flavouring may be the same.

The olfactory agent may comprise between 0.001% to 25% by weight of the attractant, preferably between 0.1% and 10% by weight and more preferably between 0.25% and 3% by weight of the attractant.

The flavouring may comprise between 0.001% to 25% by weight of the attractant, preferably between 0.1% and 10% by weight and more preferably between 0.25% to 3% by weight of the attractant.

The olfactory agent and/or the flavouring may comprise one or more natural, nature identical and/or artificial flavouring and/or olfactory compounds including those derived from extracts of plant, animal, fish, or a combination of these.

The amount or concentration of flavouring compounds and/or olfactory compounds in the flavouring/olfactory agents will determine the amount of flavouring/olfactory agent required in the attractant to provide the attractant with the desired flavouring/olfactory properties.

The olfactory agent and/or flavouring may be oil or oil-based, a fine soluble powder, micronised solid or water soluble. The attractant comprises a carrier in which the olfactory agent and/or flavouring may be suspended or dissolved, which carrier is liquid. The carrier may comprise one or more of an edible plant derived oil, such as vegetable oil, fractionated or distilled plant oil, animal derived oil such as butter oil, mineral derived oil such as pharmaceutical grade liquid paraffin and artificial/synthetic oil. Specific oils that may be used include wheat germ oil, fish oil, whole oil, marine animal/organism oil and vitamin-oil.

Preferably the carrier comprises refined oil, preferably devoid or substantially devoid of protein, thus potentially rendering the attractant hypoallergenic. The carrier is preferably devoid of or comprises only small amounts of sodium, potassium and phosphorous, whether in elemental form in the form of more complex compounds such as phospholipids, lecithin, enabling the attractant to find application to attract animals who require only very limited amounts of these to be present, such as animals with renal and/or hepatic conditions.

Preferably, the attractant is of a sprayable viscosity at normal climatic or room temperatures, and at least in the range +15° C. to +40° C.

Fractionated oils, such as those of coconut, palm oil, medium chain triglycerides may be used as the carrier or to reduce the inherent viscosity of the carrier to improve spray characteristics. Alternatively, or in addition, other viscosity reducing agents may be used, such as water, oil and water emulsion, alcohol, medium chain triglycerides such as fractionated oils of coconut and palm, thin mineral oil such as pharmaceutical grade liquid paraffin, synthetic oil, or combinations thereof.

The flavouring may have a taste, of or resembling one or more of raw, cooked, prepared or otherwise processed meat, poultry, fish, fish oil rabbit, fowl, game, turkey, mouse, rodent, bird, cheese, bacon, butter, cream, gravy, marine organism including molluscs and crustaceans, plant, yeast, seafood and/or extracts of any one or more of these, although it will be appreciated that any flavouring can be used that is found attractive to the taste sense of the target animal.

The olfactory agent may have the smell of or resembling one or more of raw, cooked, prepared or otherwise processed meat, poultry, fish, fish oil, rabbit, fowl, game, turkey, rodent, mouse, bird, cheese, bacon, butter, cream, gravy, marine organisms including molluscs and crustaceans, plant, yeast, seafood and/or extracts of any one or more of these, although it will be appreciated that any olfactory agent may be used that is found attractive to the sense of smell of the target animal.

The attractant may also comprise preservatives or other additives, such as but not limited to one or more of colourings, antioxidants, flavour enhancers, nutrients, nutritional supplements, essential fatty acids, medicament, complementary medicine, homeopathic medicine, naturopathic medicine, plant extracts, animal extracts, marine organism extracts, fish extracts, mollusc extracts, crustacean extracts, herbs, herbal and floral extracts, emulsifiers, salt and acidity regulators.

Preferably the attractant is devoid or substantially devoid of protein. This provides the attractant with hypoallergenic properties.

Preferably the attractant is devoid of or has only small amounts of sodium, potassium and phosphorous. This enables the attractant to find application with animals with renal and hepatic conditions.

The present invention also provides a method of enhancing the attractiveness of a substance for consumption by a target animal, the method comprising dispensing a liquid attractant on and/or in the substance to stimulate one or both of the smell and/or taste senses of a target animal to encourage consumption.

The attractant may be as described in any of paragraphs four to twenty above.

Preferably, the attractant is dispensed in fixed amounts which comprise a known amount of olfactory agent and/or flavouring and preferably also calories and other constituents such as medicament. Preferably, the attractant is sprayed and preferably in a diffuse spray pattern, and preferably in a generally even dispersion.

The attractant may be used to enhance the attractiveness of substances such as foodstuffs for consumption by target animals. For example, the attractant may be used to enhance the attraction of pet food to pets such as dogs, cats, rodents, fish, horses, ponies and reptiles.

Alternatively or in addition, the attractant may be used to enhance the attractiveness of substances such as medicine, dietary supplements, vitamins and minerals or the like to animals. For example, when sprayed onto medication, particularly in solid form, the odour and flavour and general palatability of the oils of the attractant help disguise the generally unpalatable nature of the medication and encourage consumption.

The attractant may be sprayed using a manually operable spray device such as a finger actuated mechanical pump spray mechanism or pressurised gas (aerosol) mechanism, which is preferably a volumetric, fixed dosage dispensing mechanism.

According to a further embodiment of the present invention there is provided an attractant product comprising a container for dispensing a liquid attractant, and an attractant contained within the container, the container being operable to dispense a fixed amount of attractant upon each actuation thereof.

The attractant may be as defined in any of paragraphs four to twenty above. The container may comprise a finger actuated mechanical volumetic pump spray dispenser operable to dispense a generally fixed and known amount of attractant, preferably in fixed volumes and/or weight upon each actuation. Alternatively, the container may comprise a pressurised gas dispensing mechanism such as an aerosol or compressible or liquefiable gas pressurised aerosol device fitted dispenser which preferably dispenses fixed and known amounts of attractant per actuation, preferably in fixed volumes.

In an alternative embodiment, the dispensing mechanism may dispense a consistent and continuous spray of attractant, enabling a known amount of attractant to be dispensed over a known period of time.

In a still further alternative the liquid attractant may be dispensed in droplets, may be, poured, pumped, brushed, dipped or drizzled onto the substance, or dispersed in any suitable way for a liquid substance. The attractant may be mixed into the substance.

Various embodiments of the present invention will now be described by way of example only.

The invention relates to animal attractants and, in particular, attractants for enhancing the attractiveness of food substances for consumption by a target animal. The attractant is in a preferred form provided as a sprayable liquid, that has organoleptic properties, that can be selectively dispensed onto the surface of or within a substance such as a food substance, generally just prior to presenting the substance to the target animal for consumption (although it will be appreciated that the attractant could be applied to the substance some while prior to presentation) to stimulate one or more, and particularly the smell and/or taste senses of a target animal and thus encourage the animal to consume the substance. The oil-based attractants of the present invention also enhance the general palatability of substances, particularly substances that are generally quite dry to the mouth. It is generally preferred that the attractant is of sprayable viscosity at normal climatic or room temperatures, such as 15° C. to 40° C.

A particular application for this technology is found in relation to pet animals, and more particularly pet cats and dogs, although it will be appreciated that the inventive concept is not restricted to such applications.

Pet animals such as cats and dogs can on occasion need encouragement by their owners, vets, carers and such like to eat their food. Often, the foodstuffs provided to pets are bland or, if the animal is fed the same foodstuff consistently, then the animal may become bored, disinterested and disinclined to consume the food. Special diets such as low protein and/or low fat diets, renal and hepatic diets often comprise bland foods. Further, circumstances such as recuperation from illness or surgery, old age, distress and the like can put pets off their food with the concomitant concerns and difficulties that arise when insufficient food is consumed.

The present invention also finds application in encouraging animals to consume other substances such as medication, dietetic supplements, vitamins, minerals, etc. Often food is used as a vehicle for animals' ingestion of medicaments, neutraceulicals, dietetic supplements, vitamins and such like. However, the strong sense of smell and/or taste of many animals often results in rejection. The attractant in the present invention provides an effective and convenient means to address such difficulties of rejection of such substances.

The attractant in one embodiment comprises a flavouring that is designed or created to be attractive to the target animal and to promote appetite. If, for example, the target animal is a cat or dog, then the flavouring will be of or will simulate flavourings known to be attractive to cats or dogs from the point of view of an attraction to consume, such as one or more animal derived flavouring or resembling flavourings such as those of one or more of raw, cooked (e.g. stewed, grilled, roasted, casseroled), prepared or otherwise processed (e.g. smoked, seasoned) beef, poultry, fish and pork. Of course, if an animal has its own attraction to particular flavourings or smells, then the appropriate attractant can be used to encourage consumption and promote appetite; others include cheese, bacon, butter, cream, fish oil, gravy, ham rabbit, game, seafood, fowl, turkey, mouse, rodent, bird, plant, yeast, marine organism including molluscs and crustaceans and/or extracts of any one or more of these.

The flavouring will have olfactory properties that positively stimulate the animal's sense of smell. This initially encourages the animal to approach the food and start to consume. The flavouring also has an attractive taste and so once the animal starts eating, the attractive taste encourages it to continue.

The flavouring may conveniently be an oil or an oil-based flavouring, to facilitate dispersement, such as suspension or dissolution in the oil or oil-based carrier or substrate. The flavouring comprises flavouring compounds and/or olfactory compounds dispersed within a diluent, such as an oil or oil-based diluent or solvent. The amount or concentration and potency of the flavouring compounds and olfactory compounds within the flavouring will be a key factor in determining the amount of flavouring that will need to be added to the carrier to give the attractant the desired flavouring and olfactory characteristics.

The flavouring can be of any suitable type or in any suitable physical state, such as a fine powder, a micronised solid, a water soluble flavouring or the like. The flavouring may be natural, nature identical synthetic, artificial or a blend of these. The flavouring may be derived from plants, animals, fish, or a combination of these.

The amount of flavouring can comprise between 0.001% and 25% by weight of the attractant within the scope of the present invention, however far flavourings currently generally commercially available amounts of between 0.1% and 10% by weight are more generally used, with more specific attractants comprising between 0.25% and 3% of flavouring by weight.

Highly concentrated and/or potent flavourings may be added in amounts as little as 0.001% of the total weight of the attractant, with considerably less concentrated flavourings potentially being added on amounts as high as 25% of the weight of the attractant. In some commercially available flavourings as little as 0.5% by weight is flavouring compounds, the rest of the composition generally being diluent. At the other end of the scale, some flavourings can consist of 100% flavouring compound t without any solvent or carrier. The choice of flavouring used for a given attractant according to the present invention and the relative amount added to the attractant composition depends upon the final characteristics of the attractant desired, but typically commercially available flavourings may be added in amounts within the aforesaid ranges.

The more usual amounts of flavouring used are in the range of 0.1% to 10% and 0.25% to 3% by weight of the attractant. For example, the commercially available beef flavouring OF9137, chicken flavouring (OF6320) and mackerel flavouring (OF2257) available from Aromco Ltd, Bell Farm Industrial Park, Nuthampstead, Hertfordshire, UK are found to provide excellent attractant properties when used in amounts in the range 0.25% to 3% wfw.

As indicated above, the preference is for the attractant to comprise a carrier in which the flavouring is suspended or dissolved. The flavouring may be added to the carrier or may be naturally occurring within the carrier. The preferred carrier comprises either wholly or substantially wholly oil. The oil can be any suitable oil, of a conveniently sprayable viscosity. For example, the carrier may comprise one or more of a plant derived oil, vegetable oil, fractionated or distilled plant oil, medium chain triglycerides, animal derived oil such as butter oil, fish oil, marine animal/organism derived oil, mineral derived oil such as pharmaceutical grade liquid paraffin or artificial/synthetic oil. Specific oils that may be used include wheat germ oil, fish oil or vitamin oil—sunflower oil, rapeseed oil, canola oil, soya bean oil, corn oil/maize oil, cotton seed oil, olive oil, sesame oil, argan oil, rice germ oil, wheat germ oil, flax germ oil, linseed oil, whale oil, borage oil, starflower oil, evening primrose oil, peanut/groundnut oil.

Fractionated oils, such as those of coconut or palm, can be used as the carrier or to reduce the inherent viscosity of the carrier oil, if necessary, to improve spray characteristics. Alternatively or in addition, other viscosity reducing agents may be used, such as water, oil and water emulsions, medium chain triglycerides, thin mineral oil such as pharmaceutical grade liquid paraffin, synthetic oil, alcohol or combinations thereof. Where necessary functional ingredients such as, emulsifying agents, wetting agents, preservatives, stabilizers, antioxidants and/or thickeners can be used to facilitate the formation and maintenance of the attractant emulsion.

Providing the attractant substantially or wholly as an oil or a combination of oils endows products of the present invention with particular advantages. Oils generally have inherent preservative characteristics and are not generally prone to spoilage through bacterial, mould or similar such infection. This provides products of the present invention with relatively good shelf life (generally about six to twelve months after manufacture) and storage under refrigeration conditions is not normally required, even after first opening or use.

Certain oil formulations can be susceptible to oxidative rancidity, but this can be mitigated by the provision of antioxidant. Generally the antioxidant would be dissolved in the carrier and may comprise one or more of tocopherol, Vitamin E, butylatedhydroxyanisole (BHA), butylatedhydroxytoluene (BHT), butylatedhydroxyquinoline (BHQ).

The oil-based products of the present invention do not generally require the addition of other preservatives such as salt (sodium chloride), potassium sorbate, sulphur dioxide or sodium benzoate. This is advantageous for two main reasons. Firstly, the addition of such preservatives could spoil the flavour and attractiveness of the flavouring to an animal, as a result of their own smell and/or taste characteristics, as well as potentially masking the more delicate flavours and/or aromas of the other constituents. Secondly, the prospective purchaser generally prefers products that do not contain additional preservatives, particularly artificial preservatives and/or elevated salt concentrations.

A further advantage of the oil-based products of the present invention is that there is generally no need for the attractant to be subjected to pasteurisation or other heat treatment which processes could detrimentally affect the olfactory and/or taste characteristics of the flavouring. Pasteurisation for example typically involves heating to between 50° C. and 90° C., temperatures that can detrimentally affect the olfactory and flavour characteristics of many flavourings and aromatics.

The oiliness of the attractant also improves general palatability, particularly of relatively dry foodstuffs.

Sterilisation typically involves heating to temperatures of between 90° C. and 150° C., which too can cause significant detriment to the characteristics of flavourings and aromatics.

The attractant may also include additives such as but not limited to one or more of colourings, flavour enhancers, vitamins, nutrients, nutritional supplements, essential fatty acids, oils generally rich in and providing a source of particular essential fatty acids such as borage oil, evening primrose oil, flax, marine oil, fish oil, wheat germ oil, medicaments, complementary medicine, homeopathic medicine, naturopathics, plant extracts, animal extracts, marine organism extracts, fish extracts, mollusc extracts, crustacean extracts, herbs, herbal and floral extracts, acidity regulators and antioxidants.

In preferred embodiments the attractant is devoid or substantially devoid of protein, thus providing the attractant with hypoallergenic advantages. Such attractants would generally be composed of refined oil(s) and flavourings chosen as being devoid or substantially devoid of protein.

In certain embodiments the attractant is devoid of or has sufficiently low levels of sodium, potassium and/or phosphorous, in elemental form or in the form of more complex compounds such as phospholipids, lecithins, to enable the attractant to be used for animals with renal and/or hepatic conditions. The use of refined oil(s) and flavourings having acceptably low or are devoid of these are used in such embodiments.

The invention also provides an attractant product which comprises a container for dispensing an attractant and an attractant contained within the container, the container being operable to dispense a fixed amount of attractant upon each actuation thereof, preferably in fixed volumes.

A particular advantage of the present invention is that the attractant can be dispensed in a controlled and regular manner, enabling the person dispensing the attractant to know and control the amount of attractant being dispensed, which can be useful in optimising the efficacy of the attractant to encourage consumption of the substance on which it is sprayed. For example, for certain animals a relatively modest amount of attractant may be required, whereas for others a larger amount may be necessary. Where the intention is to encourage the consumption of relatively large amounts of goods, generally more attractant can be dispensed.

For particular flavourings, the taste and olfactory characteristics associated therewith may be more pungent and, indeed, may be more pungent to one type of animal than another. Therefore, the ability to dispense fixed and known amounts of attractant is particularly beneficial.

Also, in embodiments of the invention where the attractant comprises additives such as medicament, dietary supplements and nutrients, knowledge of the amount of these dispensed can be important.

Further, dispensing known and fixed amounts enables the number of calories, nutrients and other constituents in the attractant to be controlled.

The dispensing mechanism of the container may be such that fixed amounts are dispensed upon each actuation of the mechanism. The mechanism may be a mechanical, piston-type mechanical pump dispensing mechanism, often referred to as “spray pumps” or “trigger pumps”. Alternative dispensing mechanisms for dispensing fixed or known amounts can be used and fail within the scope of the present invention, such as pressured gas, pneumatic, liquefied gas, part-liquefied gas propellant systems.

As an alternative, the container may dispense a consistent and continuous spray of attractant, enabling the operator to dispense a known approximate amount of attractant over a known period of time.

In use, the present invention can help to encourage animals to consume substances by enhancing the desirability of that substance for consumption and promoting appetite. A combination of the stimulation of the smell and subsequently taste senses of the target animal stimulate the animal to consume the substance, on which the attractant is sprayed. The attractant may be chosen to enhance the inherent flavour of the substance (such as a chicken flavouring attractant to enhance the flavour of foodstuffs comprising chicken), or to provide an additional or masking flavour to a foodstuff (such as adding a beef flavouring to an otherwise bland or otherwise non-attractive foodstuff).

The application of the attractant in spray form facilitates the dispensing of the attractant in a way that can have very little or no visibility to the target animal and, therefore, there is effectively no visible distraction away from consumption.

Preferably, the attractant is dispersed in a wide and diffuse spray pattern, which enables relatively light mists of attractant to be dispensed over the surface of a product in a wide and generally well distributed manner, thus facilitating consumption of more than a small part of the substance. The spray pattern may be generally even, but even if dispersed in other non-even patterns such as annular spray patterns, this coverage is sufficient to stimulate the target animal to consume the substance at least over the area of the spray pattern thereon.

### EXAMPLE 1

This is an example of a simple formulation for an attractant according to the present invention.

| | | |
|---|---|---|
| Refined oil substrate/carrier | 99% | (80% to 99.99%) w/w |
| Flavouring | 1% | (0.01% to 20%) w/w |

Other relatively minor ingredients, functional ingredients or additives can be provided, such as preservatives, antioxidants, thinning agents (to improve spray characteristics), colouring, flavour enhancers, nutrients, dietary supplements, medicaments, complementary medicine, homeopathic medicine, naturopathics, plant extracts, animal extracts, marine organism extracts, mollusc extracts, crustacean extracts, herbs, herbal and floral extracts, acidity regulators, vitamins, nutritional supplements, essential fatty acids, borage oil, evening primrose oil, flax, marine oil, fish oil, wheat germ oil.

### EXAMPLE 2

| | | |
|---|---|---|
| Refined rapeseed oil | 48.4% | w/w |
| Refined evening primrose oil | 50.55% | w/w |
| Refined flax oil | 0.50% | w/w |
| Chicken flavouring | 0.50% | w/w |
| Tocopherols concentrate (antioxidant) | 0.05% | w/w |

In this composition the carrier is composed of the three oils, rapeseed, evening primrose and flax oil, to provide 99.45% by weight of the entire composition of the attractant.

The chicken flavouring is provided as an oil soluble concentrate available from Aromco Ltd, Bell Farm Industrial Park, Nuthampstead, Hertfordshire, UK under reference OF6320.

This composition has been found to exhibit excellent attractant properties, particularly to encourage domestic cats and dogs to consume food substances, medication, dietetic supplements and the like.

In this composition the level of crude protein present is less than 0.1 g/100 g, thus rendering it hypoallergenic. Also, the level of phosphorous is less than 0.0002 g/100 g, potassium less than 0.005 g/100 g and sodium less than 0.001 g/100 g, thus enabling the attractant to be used for animals with renal and/or hepatic conditions requiring low levels of these in the diet.

### EXAMPLE 3

| | | | |
|---|---|---|---|
| Sunflower oil | 60% | w/w | |
| Vegetable oil | 29.9% | w/w | |
| Beef flavouring | 10% | w/w | Aromco-OF9137 |
| Antioxidant | 0.1% | w/w | |

In this composition the beef flavouring is provided in an amount of 10% w/w as the concentration of the flavouring itself requires this level to be present to provide the desired aromatic and flavouring characteristics and thus attractive properties of the attractant.

### EXAMPLE 4

This is an example of an attractant of the present invention wherein the flavouring is naturally occurring within the substrate/carrier.

| | |
|---|---|
| Marine fish oil | 100% w/w |

Other relatively minor (by weight) constituents can be added, such as but not limited to antioxidants, thinning agents, colouring, nutrients, medicaments, complementary medicine, homeopathic medicines, naturopathics, plant extracts, herbs, herbal and floral extracts, acidity regulators, flavour enhancers, animal extracts, marine organism extracts, mollusc extracts, crustacean extracts, vitamins, nutritional supplements, essential fatty acids, borage oil, evening primrose oil, flax, marine oil, fish oil, wheat germ oil.

### EXAMPLE 5

| | | | |
|---|---|---|---|
| Carrier Oil | 99.9% | w/w | |
| Mackerel Flavouring | 0.05% | w/w | Aromco-OF2257 |
| Antioxidant | 0.05% | w/w | |

In all of the above examples, refined forms of the oil(s) can be used to produce hypoallergenic attractant and attractant sufficiently low in sodium, potassium and/or phosphorous to enable use with animals with renal and/or hepatic conditions.

Various modifications may be made without departing from the spirit or scope of the present invention.

In the above embodiments the attractant comprises a flavouring that has both attractive olfactory and taste characteristics, as this is considered the more likely embodiment. However, it is within the scope of the present invention for the olfactory agent to be a different substance or ingredient to the flavouring, although the characteristics of the olfactory agent will be generally as described above in relation to the flavourings. In embodiments where both flavourings and olfactory agents are present, the amounts of each can be within the ranges set out hereinbefore in relation to the flavouring only, or alternatively the combined amounts of the flavouring and olfactory agent can be within the respective ranges.

The target animal could be any animal including pet animals, wild animals, humans, mammals, birds, reptiles, amphibians, insects.

The attractant may be dispensable by means other than spraying. For example the attractant could be poured, pumped, brushed, mixed, dropped, counted by drop from a dropper, dripped, drizzled or otherwise dispensed onto the substance for consumption.

The attractant may be used to enhance the attractiveness of substances other than food for consumption, such as medicine, vitamin and minerals, food supplements, dietetic preparations and such like in one or more of liquid, tablet, capsule, powdered or other suitable form.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-38. (canceled)

39. An attractant for enhancing the attractiveness of a substance for consumption by a target animal, the attractant being devoid of protein and comprising a carrier being wholly or substantially wholly oil and one or both of an olfactory agent present in an amount of 0.001% to 25% by weight of the attractant and flavoring present in an amount of 0.001% to 25% by weight of the attractant, the olfactory agent and/or flavoring being dispersed in the carrier such that the attractant when dispensed on and/or in a substance stimulates one or both of the smell and/or taste senses of a target animal, to encourage consumption.

40. An attractant as claimed in claim 39, in which the attractant is sprayable.

41. An attractant as claimed in claim 39, in which the attractant enhances the inherent attractiveness of a foodstuff for consumption by a target animal.

42. An attractant as claimed in claim 39, in which the olfactory agent is present in an amount between 0.1% and 10% by weight of the attractant.

43. An attractant as claimed in claim 39, in which the olfactory agent is present in an amount between 0.25% and 3% by weight of the attractant.

44. An attractant as claimed in claim 39, in which the flavoring is present in an amount between 0.1% and 10% by weight of the attractant.

45. An attractant as claimed in claim 39, in which the flavoring is present in an amount between 0.25% and 3% by weight of the attractant.

46. An attractant as claimed in claim 39, in which the olfactory agent and flavoring are the same.

47. An attractant as claimed in claim 39, in which the flavorings and/or olfactory agent is/are dissolved and/or suspended in the carrier.

48. An attractant as claimed in claim 39, in which the attractant is of a sprayable viscosity in the range +15° C. to +40° C.

49. An attractant as claimed in claim 39, in which the attractant is sprayable and comprises fractionated oils, such as those of coconut, palm oil, medium chain triglycerides to reduce the inherent viscosity of the oil to improve spray characteristics.

50. An attractant as claimed in claim 39, in which the attractant comprises viscosity reducing agents, such as water, alcohol, water and oil emulsion, medium chain triglycerides, thin mineral oil, or a combination thereof.

51. An attractant as claimed in claim 39, in which the attractant is hypoallergenic.

52. A method of enhancing the attractiveness of a substance for consumption by a target animal, the method comprising dispensing a liquid attractant as claimed in claim 39, on and/or in the substance to stimulate one or more of the sense(s) of the target animal to encourage consumption.

53. A method as claimed in claim 52, in which the attractant is dispensed in fixed amounts which comprise a known amount of olfactory agent and/or flavoring.

54. A method as claimed in claim 52, in which the attractant is dispensed in fixed amounts which comprise a known number of calories and amount of constituents such as medicament.

55. A method as claimed in claim 52, in which the attractant is sprayed in a diffuse spray pattern to enable wide dispersion on the substance.

56. An attractant product comprising a container for dispensing a liquid attractant, and a liquid attractant contained within the container, the container being operable to dispense a known amount of attractant upon each actuation thereof.

57. An attractant product as claimed in claim 56, comprising an attractant for enhancing the attractiveness of a substance for consumption by a target animal, the attractant being devoid of protein and comprising a carrier being wholly or substantially wholly oil and one or both of an olfactory agent present in an amount of 0.001% to 25% by weight of the attractant and flavoring present in an amount of 0.001% to 25% by weight of the attractant, the olfactory agent and/or flavoring being dispersed in the carrier such that the attractant when dispensed on and/or in a substance stimulates one or both of the smell and/or taste senses of a target animal, to encourage consumption.

58. An attractant as claimed in claim 54, in which a dispensing mechanism dispenses a continuous spray of attractant, enabling an approximate amount of attractant to be dispensed over a known period of time.
